(19) United States
(12) Patent Application Publication
(10) Pub. No.: US 2015/0095843 A1
(43) Pub. Date: Apr. 2, 2015

(54) Single-hand Interaction for Pan and Zoom

(71) Applicant: Microsoft Corporation, Redmond, WA (US)

(72) Inventors: Pierre Paul Nicolas Greborio, Sunnyvale, CA (US); Michel Pahud, Kirkland, WA (US)

(73) Assignee: Microsoft Corporation, Redmond, WA (US)

(21) Appl. No.: 14/040,010

(22) Filed: Sep. 27, 2013

(51) Int. Cl. G06F 3/0485; G06F 3/0481

(52) U.S. Cl. CPC G06F 3/0485; G06F 3/0481
USPC 715/784

(57) ABSTRACT

Systems and methods for presenting a dynamic user-interaction control are presented. The dynamic user-interaction control enables a device user to interact with a touch-sensitive device in a single-handed manner. A triggering event causes the dynamic user-interaction control to be temporarily presented on a display screen. In various embodiments, a dynamic user-interaction control is presented at the location corresponding to the triggering event (i.e., the location of the device user's touch). The dynamic user-interaction control remains present on the display screen and the device user can interact with the control until a dismissal event is encountered. A dismissal event occurs under multiple conditions including the device user breaks touch connection with the dynamic user-interaction control for a predetermined amount of time.

### BACKGROUND

As people continue to use their hand-held mobile devices as a phone for telecommunication, more and more these same people are also using their mobile devices as content consumption devices. Through their mobile devices, people can “consume” (i.e., view and interact with) content such as maps, images, videos, web content, email, text messages, and the like. Additionally, a growing percentage of these mobile devices are touch-sensitive, i.e., a user interacts with the device, as well as content presented on the device, through the device's touch-sensitive display surface.

Quite often, the content that a user wishes to display on the mobile device is substantially larger than the mobile device's available display surface, especially when the content is displayed in full zoom. When this is the case, the user must decrease the zoom level (shrinking the size of the content) of the displayed content or must reposition the device's viewport with respect to the displayable content, or both. While there are user interface techniques for modifying the zoom level of content (e.g., pinching or spreading one's fingers on a touch-sensitive surface) or repositioning the content/display surface (via pan or swiping gestures), these techniques are generally considered two-handed techniques: one hand to hold the mobile device and one hand to interact on the touch-sensitive display surface. However, there are many occasions in which the user has only one free hand with which to hold the device and interact with the display surface. In such situations, fully interacting with content displayed on the mobile device is difficult, if not impossible. On wall-mounted or tabletop displays with direct touch, there is no issue of holding the device. However, on such large form factors the pinch and swipe technique can be very tiring and zooming might require two hands.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, a dynamic user-interaction control is presented that enables a person to interact with a touch-sensitive device in a single-handed manner. A triggering event causes the dynamic user-interaction control to be temporarily presented on a display screen. Generally, the dynamic user-interaction control is presented on the display window of the display screen. In one embodiment, the triggering event occurs when the device user touches a touch-sensitive input device and holds that touch for a predetermined amount of time. Typically, the dynamic user-interaction control is presented at the location corresponding to the triggering event (i.e., the location of the device user's touch). The dynamic user-interaction control remains present on the display screen and the device user can interact with the control until a dismissal event is encountered. A dismissal event occurs under multiple conditions including the device user breaks touch connection with the dynamic user-interaction control for a predetermined amount of time.

According to additional aspects of the disclosed subject matter, a method for interacting with content displayed in a display window is presented. A triggering event for interacting with content displayed in a display window is detected. Upon detection of the triggering event, a dynamic user-interaction control is displayed on the display window. User activity in regard to the dynamic user-interaction control is detected and a determination is made as to whether the detected user activity corresponds to a panning activity or a zooming activity. The detected user activity is implemented with regard to the display of the content in the display window.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating an exemplary mobile device configured for implementing aspects of the disclosed subject matter;

FIG. 2 is a pictorial diagram illustrating the exemplary mobile device of FIG. 1 as used for continuous panning over displayed content;

FIG. 3 is a pictorial diagram illustrating the panning of a display window with respect to the content being displayed under continuous panning;

FIG. 4 is a pictorial diagram illustrating the exemplary mobile device of FIG. 1 as used for zooming with regard to displayed content;

FIG. 5 is a pictorial diagram illustrating the exemplary mobile device of FIG. 1 illustrating a multi-mode dynamic user-interaction control;

FIGS. 6A and 6B present a flow diagram of an exemplary routine for providing device user interaction with a dynamic user-interaction control; and

FIG. 7 is a block diagram illustrating exemplary components of a computing device suitable for implementing aspects of the disclosed subject matter.

### DETAILED DESCRIPTION

For purposed of clarity, the term “exemplary” in this document should be interpreted as serving as an illustration or example of something, and it should not be interpreted as an ideal and/or a leading illustration of that thing. A display window refers to the area of display screen that is available for displaying content. The display window may comprise the entirety of a display screen, but that is not required.

The term panning refers to the act of changing the content that can be viewed through a display window such that a portion of the content that was previously displayed in the display window is no longer visible while a portion of the content that was not previously displayed in the display window becomes visible. Similar to panning, “flicking” involves quickly dragging the point of contact (such as the touch location of a finger) across an area of the screen and releasing contact. Flicking causes a panning/scrolling action to continue for a period of time, as though there were momentum provided by the flicking gesture, along the vector defined the original contact location and the release location. The speed of the flicking gesture determines the speed of scrolling and the momentum imparted and, therefore, the continued scrolling after contact is released. Panning and flicking typically involve content that cannot be fully displayed at a current resolution within a display window, i.e., there is more content that can be displayed by the display window. Conceptually, one may think of moving the display window over the content. Alternatively, one may think of a fixed display window and the content is moved underneath. The following discussion will be made in the context of the former: that of moving the display window over the content, but this is for simplicity and consistency in description and is not limiting upon the disclosed subject matter. Panning typically involves a smooth transition in the content (based on the speed of panning) but this is not a requirement. Panning and scrolling (with regard to the repositioning of the display window to the content) are used synonymously.

The term zoom refers to the resolution of the displayed content through a display window. Conceptually, one may think of zoom as referring to the distance of the display window to the content: the further away the display window is from the content the less resolution and/or detail of the content can be displayed, but more of the content can be displayed within the display window. Conversely, the closer the display window is “zoomed in” to the content, the greater the resolution and/or detail of the content can be displayed, but the amount (overall area) of content that can be displayed in the display window is reduced.

According to aspects of the disclosed subject matter, a dynamic user-interaction control is presented that enables a person to interact with a touch-sensitive device in a single-handed manner. A triggering event causes the dynamic user-interaction control to be temporarily presented on a display screen. Generally, the dynamic user-interaction control is presented on the display window of the display screen. In one embodiment, the triggering event occurs when the device user touches a touch-sensitive input device and holds that touch for a predetermined amount of time. Typically, the dynamic user-interaction control is presented at the location corresponding to the triggering event (i.e., the location of the device user's touch). The dynamic user-interaction control remains present on the display screen and the device user can interact with the control until a dismissal event is encountered. A dismissal event occurs under multiple conditions including the device user breaks touch connection with the dynamic user-interaction control for a predetermined amount of time.

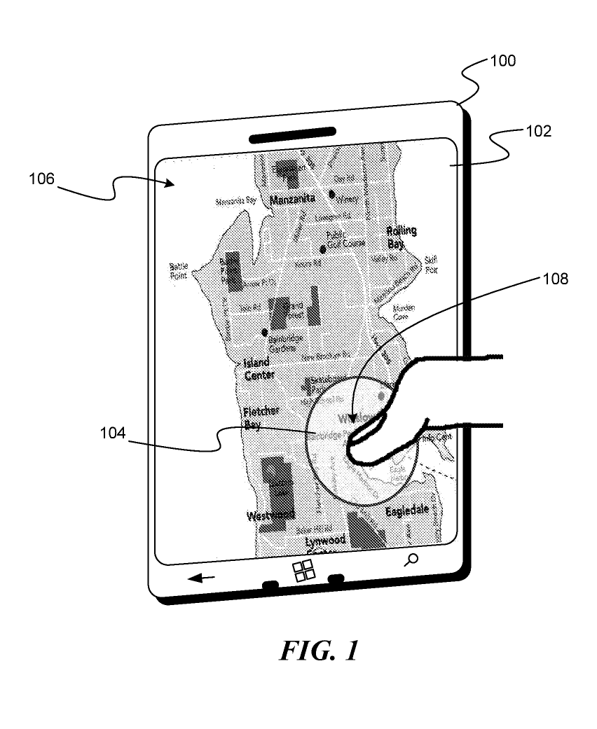

Turning now to the figures, FIG. 1 is a pictorial diagram illustrating an exemplary mobile device 100 configured to implement aspects of the disclosed subject matter. More particularly, the mobile device 100 is shown as a hand-held mobile phone having a touch-sensitive display window 102. Examples of hand-held mobile devices include, by way of illustration and not limitation, mobile phones, tablet computers, personal digital assistants, and the like. Of course, as will be discussed below, aspects of the disclosed subject matter are not limited to hand-held mobile devices, such as mobile device 100, but may be implemented on a variety of computing devices, and/or display devices. For example, the disclosed subject matter may be advantageously implemented with regard to one or more wall screens or tabletop displays. It can also work on touchpads or other devices that don't have a display. The dynamic user-interaction control could also work across devices such as a smartphone with the dynamic user-interaction control on it controlling the navigation on a wall-mounted display.

As shown in FIG. 1, the exemplary mobile device 100 includes a display window 102 through which content may be displayed. More particularly, for purposes of illustration the content that the display window 102 currently displays is a map 106, though any type of content may be displayed in conjunction with the inventive aspects of the disclosed subject matter. As will be readily appreciated, frequently a device user requests the display of content, via the display window 102, that is often much larger in size that the available area offered by the display window, especially when the content is displayed at full resolution. For purposes of the present example (as shown in FIG. 1 and as discussed in regard to subsequent figures) the map 106 is much larger than can be displayed by the display window 102 at the present resolution.

FIG. 1 also illustrates the results of the device user causing a triggering event to occur on the mobile device 102. More particularly, in response to the occurrence of a triggering event a dynamic user-interaction control 104 is presented on the display window 102. As shown in FIG. 1, the dynamic user-interaction control 104 is typically (though not exclusively) presented at the location 108 corresponding to where the triggering event occurs, e.g., the location 108 on the display window 102 where the device user touches the touch-sensitive screen.

According to aspects of the disclosed subject matter, a triggering event may be caused by the device user touching and remain touching a location on a touch sensitive surface (e.g., the touch sensitive display window 102) for a predetermined amount of time. In a non-limiting example, the predetermined amount of time is 1 second. As will be appreciated, touching and maintaining contact on the touch-sensitive display window 102 may be readily accomplished with one hand, such as pressing and touching the touch-sensitive display window with a thumb as shown in FIG. 1. Of course, other gestures and activities may also cause the dynamic user-interaction control 104 to be presented. For example, on mobile devices equipped to detect motion, a triggering event may correspond to a particular motion or shaking of the device. Alternatively, a particular gesture made on the touch sensitive display window 102 may cause a triggering event to occur. Still further, there may be multiple manners that a triggering event may be triggered including speech/audio instructions. Accordingly, while the subsequent discussion of a triggering event will be made in regard to touching and maintaining contact at that location with the touch-sensitive display window 102 for a predetermined amount of time, it should be appreciated that this is illustrative and not limiting upon the disclosed subject matter.

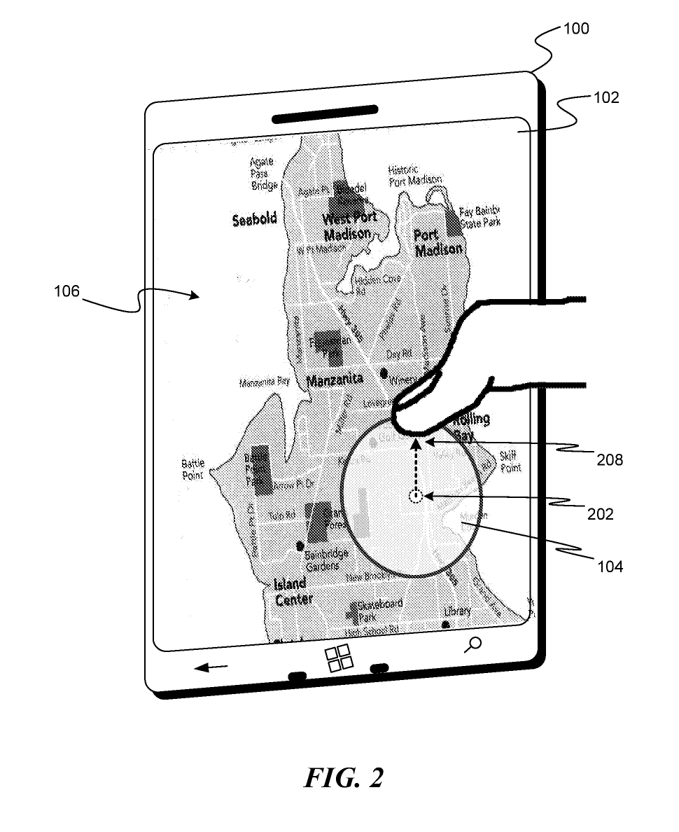

Turning now to FIG. 2, FIG. 2 is a pictorial diagram illustrating the exemplary mobile device 100 of FIG. 1 and illustrating user interaction with the dynamic user-interaction control 104 for continuous panning over the displayed content (in this example the map 106). In particular, after having triggered the presentation of the dynamic user-interaction control 104 by way of a triggering event, the device user can interact with the dynamic user-interaction control. Touching a location, such as origin touch location 202 in the dynamic user-interaction control 104 and dragging the user's touch away from that location causes the content (i.e., map 106) displayed in the display window 102 to be scrolled with regard the display window, i.e., a portion of content that was not previously displayed in the display window 102 is moved into the display window while a portion of content that was previously displayed in the display window is moved out of the display window.) According to aspects of the disclosed subject matter, the continuous panning operates in a similar manner to typical joystick movements, i.e., the content displayed in the display window is scrolled/moved in the opposite direction that the user dragged such that new content located in the direction of the device user's drag motion is brought into the display window 102. As long as the user maintains contact with the touch surface, the panning/scrolling continues, thereby causing continuous panning/scrolling. The amount or rate of scrolling of the content with regard to the display window 102 is determined as a function of the distance between the origin touch location 102 and a current touch location 208. According to additional aspects of the disclosed subject matter, while maintaining contact with the touch-sensitive display window 102, changing the current touch location causes the panning/scrolling to be updated (if necessary) in direction of the new current touch location from the origin touch location 202 and the rate of panning/scrolling is determined according to the distance of the new current touch location from the origin touch location. When the device user breaks contact with the touch surface (a terminating event), panning ceases.

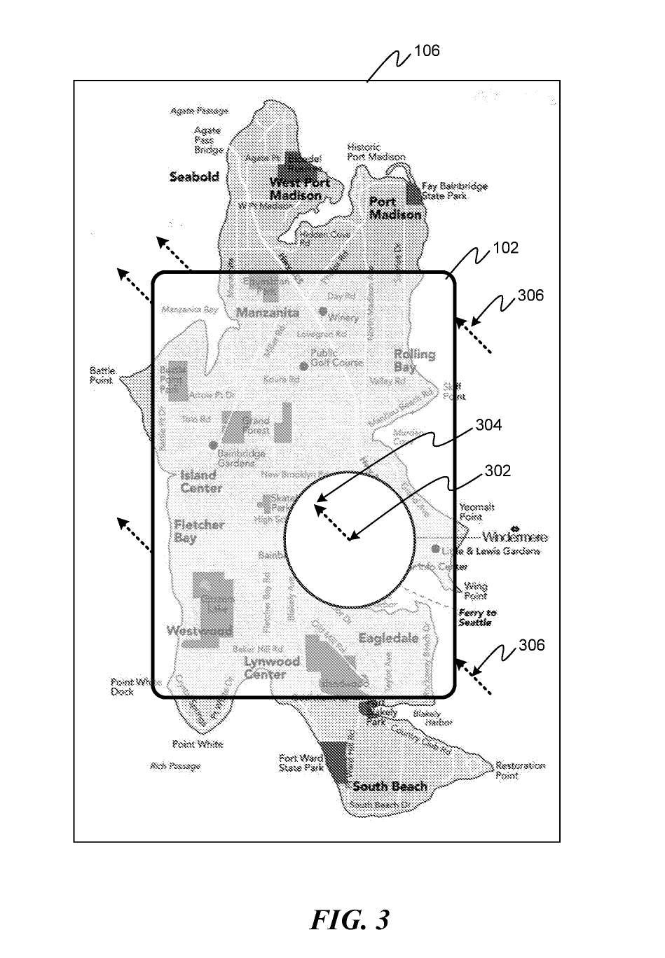

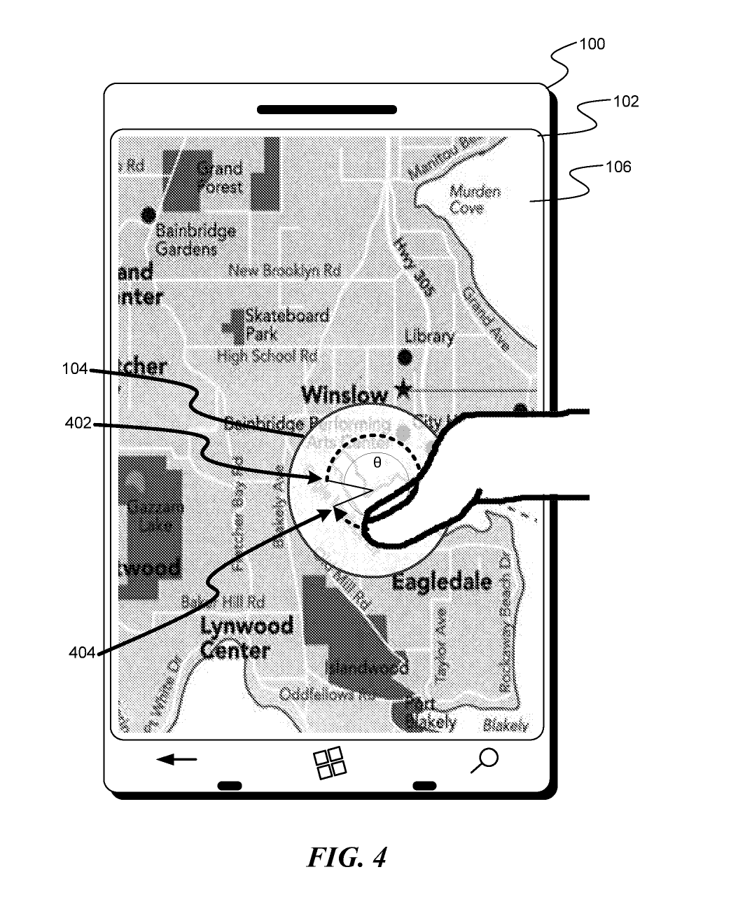

FIG. 3 is a pictorial diagram for illustrating the panning of a display window 102 with respect to the content 106 being displayed under continuous panning. As can be seen, in response to a device user touching and dragging to a current touch location 304 from an origin touch location 302, the display window 102 is moved along that same vector (defined by the origin touch location to the current touch location in a Cartesian coordinate system) with respect to the underlying content (map 106) as indicated by arrows 306. As will be discussed further below, a magnitude is determined according to the rotational angle/distance (as denoted by “θ” in FIG. 4) between the origin touch and the current touch locations. This magnitude/distance controls the speed of panning/scrolling in of the underlying content.

In addition to panning, the dynamic user-interaction control 104 also enables the device user to alter the resolution/zoom of the content (i.e., simulate movement toward or away from the content such that the content may be viewed in differing resolutions and sizes). FIG. 4 is a pictorial diagram illustrating the exemplary mobile device 102 of FIG. 1 as used for zooming with regard to displayed content 106. In contrast to the action to initiate panning, by touching a location within the dynamic user interaction control 104 and circling (moving along an arc) within control the device user initiates a zoom action. According to aspects of the disclosed subject matter, circling within the dynamic user-interaction control 104 in a clockwise (as shown in FIG. 4) zooms in (conceptually moves closer to the content such that more resolution is displayed but less of the overall content.) Conversely, counter-clockwise circling within the dynamic user interaction control 104 causes the display window to zoom out from the displayed content. As shown in FIG. 4, as device user circles in a clockwise manner (as indicated by the dashed arrow) from the origin touch location 402 to the current touch location 404, the display window 102 zooms in closer to the map 106 such that greater resolution of the displayed content (map 106) is shown but at the cost of less of the overall content being displayed. As with continuous panning, according to aspects of the disclosed subject matter, as long as the device user maintains contact the zoom feature is operational. However, in contrast to continuous panning, zooming is tied to the distance around a point within the dynamic user-interaction control 104 based on the current touch location 404 from the origin touch location 402. Moreover, the rate of zoom (both in and out) is tied to the degree of rotation. Of course, the user is not limited to a 360 degree circle, but can continue to circle to zoom more.

While both panning and zooming are initiated within the dynamic user-interaction control 104, it should be appreciated that the user interaction need not be contained within the limits of the control. Indeed, the user interaction for panning will often exit the extent of the dynamic user-interaction control 104. Similarly, while the zooming interaction is determined according to rotation around an origin, the rotation may occur outside of the displayed limits of the dynamic user-interaction control 104.

Regarding the origin around which the rotation (and therefore zoom) is determined, the above description has been made in regard to the origin corresponding to the original touch location which also corresponds to the center of the dynamic user-interaction control 104. However, this is an example of only one embodiment of the disclosed subject matter. In alternative embodiments, the origin may correspond to the center of the touch-sensitive surface and/or the center of the display screen. Alternatively still, the origin may be dynamically established to correspond to the location of the beginning of the zoom activity/interaction. Still further, the origin may be dynamically determined based on the circular motion of the user's interaction. Of course, the center of the zoom may correspond to other locations, such as the center of the display screen. Further still, the center of zoom may be determined by any number of methods, including being established by another touch with a finger or stylus.

Regarding the circular motions that control zooming, while the above discussion is made in regard to clockwise corresponding to zooming in and counter-clockwise zooming out, this is illustrative of one embodiment and should not be construed as limiting upon the disclosed subject matter. While the discussed arrangement may work well for some, an alternative arrangement may be similarly utilized: where counter-clockwise motions correspond to zooming in and clockwise motions correspond to zooming out.

The dynamic user-interaction control 104 may be dismissed via a dismissal event initiated in any number of ways. According to one embodiment, the dynamic user-interaction control 104 is dismissed from the display window 102 by a dismissal event caused by breaking contact with the control for a predetermined amount of time. For example, 2 seconds after the device user breaks contact (and does not re-initiate contact with the dynamic user-interaction control 104 in the touch sensitive surface) a dismissal event is triggered. Alternatively, by breaking contact with the dynamic user-interaction control 104 and/or interacting with the touch-sensitive surface (e.g., the touch sensitive display window 102) outside of the control a dismissal event is triggered.

Advantageously, by providing a predetermined amount of time after breaking contact with the touch-sensitive surface, the device use can resume activity in that time by touching within the dynamic user-interaction control 104 and either panning or zooming (as described above. In this way, the device user can both pan and zoom without bringing the dynamic user-interaction control 104 up twice. For example, the device user may trigger the display of the dynamic user-interaction control 104 and tart with a zoom, break contact for less than the predetermined amount of time it takes to trigger a dismissal event, touch again within the control perform a pan or zoom action.

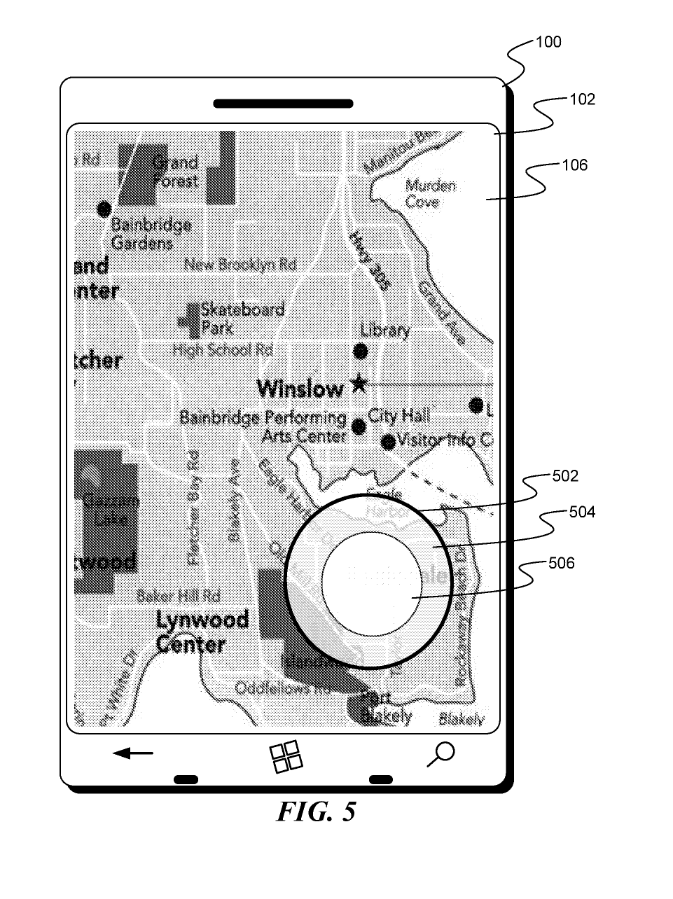

Turning now to FIG. 5, FIG. 5 is a pictorial diagram illustrating the exemplary mobile device 100 of FIG. 1 illustrating a multi-mode dynamic user-interaction control 502. In particular, FIG. 5 shows a dynamic user-interaction control 502 with two interaction areas. According to one embodiment of the disclosed subject matter, the outer area 504 is for zoom such that touching within the outer area commences a zoom activity (i.e., any movement around zooms in or out of the content), while making a touch within the inner area 506 commences a panning activity.

To illustrate how the disclosed subject matter may work, the following is provided by way of example. On a touch-sensitive screen, the user touches and holds the touch for a predetermined amount of time (such as 0.5 seconds). Holding the touch means that the user maintains contact with the touch-sensitive surface and moves from the original touch location less than some threshold value for the predetermined amount of time. Holding the touch for that predetermined amount of time is recognized as a triggering event and causes a dynamic user interface control (such as user interface control 502 of FIG. 5) to be displayed. Without releasing the touch after the control 502 is displayed, and with the touch in the inner area 506, as the use drags the touch a corresponding pan operation occurs. It should be noted that the user could pan in an arc but because of the multi-modal nature of the dynamic user-interaction control 502 and because the user began the interaction within the panning area 506, the activity is interpreted as a panning action and panning occurs as described above. In various embodiments, the pan may exceed the bounds of the inner area 506, even outside of the control 502, so long as it was initiated within the control 502 (i.e., within the inner area 506).

Continuing the example of above, the user may release the touch (after panning) and if the user initiates another touch with the dynamic user-interaction control 502 within another predetermined threshold amount of time (e.g., 2 seconds) then another interaction with the control is interpreted. Assume this time that the user initiates another interaction within the outer area 504 of the dynamic user-interaction control 502 within the second predetermine threshold. Now the system interprets the interaction as a zoom because the user is touching within the outer area 504. As the user rotates around the origin of the control 502, a corresponding zooming action is made with regard to the underlying content 106. After the user releases the touch and the second time period (the second predetermined amount of time) expires without the user interacting within the dynamic user-interaction control 502, the control is dismissed. In various embodiments, the zoom may exceed the bounds of the inner area 504, even outside of the control 502, so long as it was initiated within the control 502 (i.e. within the inner area 504).

While the disclosed subject matter has been described in regard to a mobile device 100 having a touch-sensitive display window 102, the disclosed subject matter is not limited to operating on this type of device. Indeed, the disclosed subject matter may be suitably applied to any number of other computing devices, including those that are typically not considered mobile devices. These other devices upon which the disclosed subject matter may operate include, by way of illustration and not limitation: a tablet computer; a laptop computer; all-in-one desktop computers; a desktop computer; television remote controls; computers having wall-mounted displays; tabletop computers; and the like. Each of these may have an integral or external touch-sensitive input area that may or may not correspond to the display window. For example, aspects of the disclosed subject matter may be implemented on a laptop having a touchpad. As suggested in the non-exclusive list of devices that may take advantage of the disclosed subject matter, while a suitable device receives input via a touch-sensitive surface for interacting with displayed content, the touch-sensitive surface need not be the display window 102. Of course, when the input device and the display device are not the same, suitable indicators may be displayed on the dynamic user interface control 104 indicating the origin location as well as the current location.

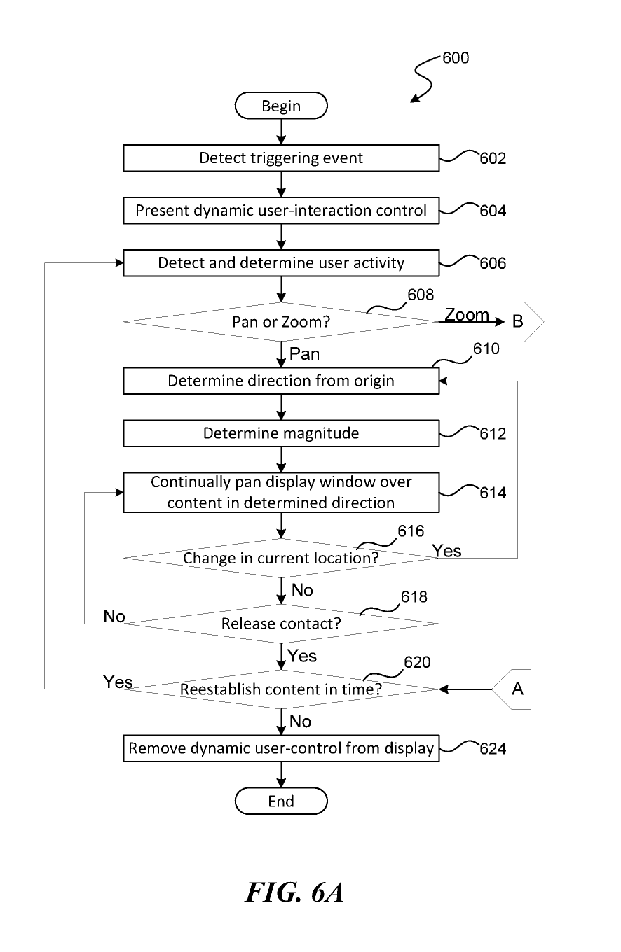

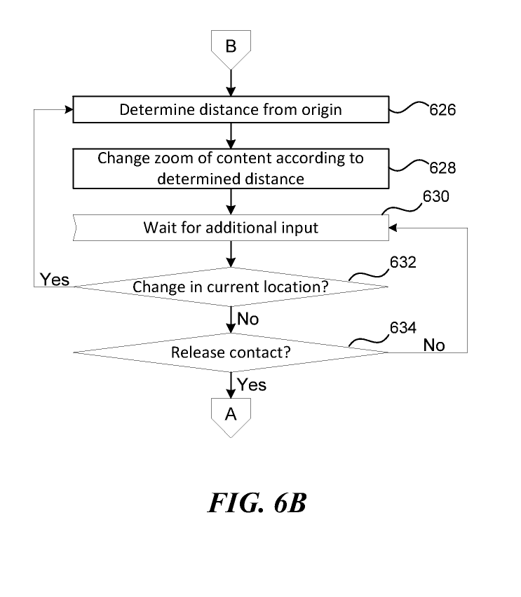

Turning now to FIGS. 6A and 6B, FIGS. 6A and 6B present a flow diagram of an exemplary routine 600 for providing device user interaction with a dynamic user-interaction control. Beginning at block 602, a triggering event for initiating the display of a dynamic user-interaction control 104 on the computer display. At block 604, in response to the triggering event a dynamic user-interaction control 104 is presented/displayed. At block 606, a determination is made as to what type of user activity the device user is making with regard to the dynamic user-interaction control 104, i.e., determining whether it is a pan or a zoom activity. Of course, while not shown in illustrated method 600, at this point the device user may opt to not interact with the dynamic user-interaction control 104 and, after the predetermined amount of time, the control would be dismissed from the display.

At decision block 608, a determination is made as to whether the activity was a pan or a zoom. This determination may be based on the particular nature of the user interaction (i.e., if the user forms an arc that may be indicative of a zoom or if the user moves away from the user interaction point that may be indicative of a pan) or the location of the user interaction: whether the user interacts (and/or initiate the interaction) within an area designated for panning or within an area designated for zooming. If the activity was a zoom, the routine 600 proceeds to label B (FIG. 6B), as will be discussed below. Alternatively, if the activity was a pan, the routine 600 proceeds to block 610. At block 610, a determination is made as to the direction (in a Cartesian coordinate system) of the current location from the origin location. As mentioned above, this direction determines the direction of the pan of the display window 102 with regard to the displayed content. At block 612, a second determination is made as to magnitude of the pan, i.e., the distance of current location from the origin location. This magnitude is then used in a predetermined function to determine the rate of panning/scrolling of the display window 102 with regard to the content. At block 614, a continuous panning is commenced in the determined direction and at the determined panning speed. This continuous panning continues until contact is broken or the device user changes the current location. Of course, if the display window is at the extent of the underlying content, no panning will occur though the method may continue to function as though it is panning.

At block 616, a determination is made as to whether there has been a chance in the current location. If there has been a change, the routine 600 returns to block 610 to re-determine the direction and magnitude for continuous panning. Alternatively, if there has not been a change, the routine 600 proceeds to block 618 where a further determination is made as to whether the device user has released contact with the input device. If the device user has not released contact the routine 600 returns to block 614 to continue the continuous panning.

If, at block 618, the device user has released contact (a release event), the routine 600 proceeds to decision block 620. At decision block 620, a determination is made as to whether the device user has re-established contact with the dynamic user-interaction control 104 within the predetermined amount of time. If yes, the routine 600 returns to block 606 where a determination as to the device user's new user activity with the dynamic user-interaction control 104 is made. However, if not, the routine 600 proceeds to block 624 where the dynamic user-interaction control 104 is removed from display. Thereafter, the routine 600 terminates.

With regard to zooming, if at decision block 608 the user activity is in regard to zooming, the routine 600 proceeds through label B (FIG. 6B) to block 626. At block 626, the amount of rotation of the current location from the origin location (as measured in degrees or radians) is determined. At block 628, the zoom of the underlying content is changed according to the determined rotational angle. At block 630, the method 600 awaits additional device user input. At decision block 632, if there has been a change in the current location (i.e., continued zoom activity), the routine 600 returns to block 626, and repeats the process as described above. However, if it is not a change in location, the routine 600 proceeds to decision block 634. At decision block 634, a determination is made as to whether the device user activity was a release of contact. If it was not a release of contact, the routine 600 returns to block 630 to await additional activity. Alternatively, if the device user has released contact, the routine proceeds through label A (FIG. 6A) to decision block 620 to continue the process as described above.

While many novel aspects of the disclosed subject matter are expressed in routines (such as routine 600 of FIGS. 6A and 6B) embodied in applications, also referred to as computer programs, apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions stored on the computer-readable storage devices are executed, they carry out various steps, methods and/or functionality, including the steps described above in regard to routine 600. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

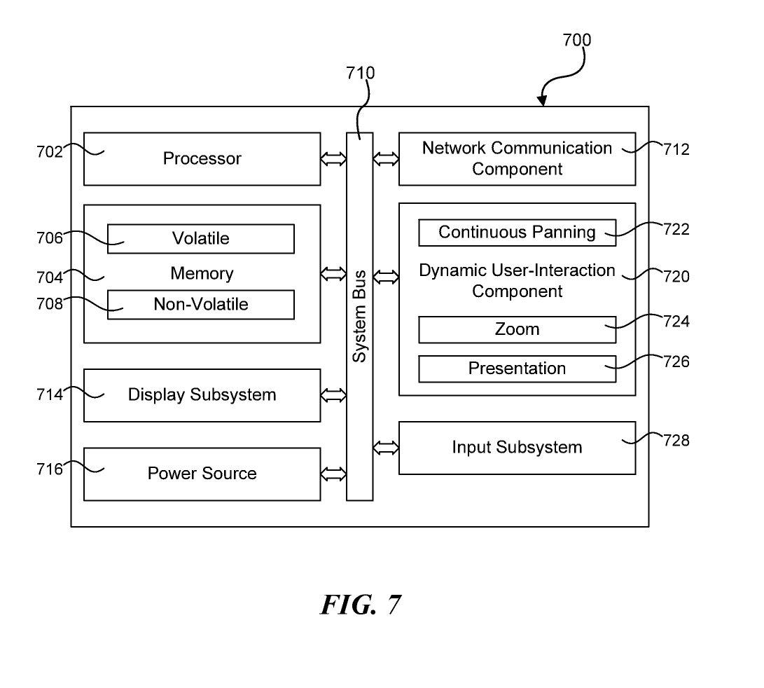

Turning now to FIG. 7, FIG. 7 is a block diagram illustrating exemplary components of a computing device 700 suitable for implementing aspects of the disclosed subject matter. As shown in FIG. 7, the exemplary computing device 700 includes a processor 702 (or processing unit) and a memory 704 interconnected by way of a system bus 710. As those skilled in the art will appreciated, memory 704 typically (but not always) comprises both volatile memory 706 and non-volatile memory 708. Volatile memory 706 retains or stores information so long as the memory is supplied with power. In contrast, non-volatile memory 708 is capable of storing (or persisting) information even when a power source 716 is not available. Generally speaking, RAM and CPU cache memory are examples of volatile memory whereas ROM and memory cards are examples of non-volatile memory. Other examples of non-volatile memory include storage devices, such as hard disk drives, solid-state drives, removable memory devices, and the like.

The processor 702 executes instructions retrieved from the memory 704 in carrying out various functions, particularly in regard to presenting a dynamic user interaction control. The processor 702 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; game consoles, and the like.

The system bus 710 provides an interface for the various components to inter-communicate. The system bus 710 can be of any of several types of bus structures that can interconnect the various components (including both internal and external components). The exemplary computing device 700 may optionally include a network communication component 712 for interconnecting the computing device 700 with other computers, devices and services on a computer network. The network communication component 712 may be configured to communicate with these other, external devices and services via a wired connection, a wireless connection, or both.

The exemplary computing device 700 also includes a display subsystem 714. It is through the display subsystem 714 that the display window 102 displays content 106 to the device user, and further presents the dynamic user-interaction control. The display subsystem 714 may be entirely integrated or may include external components (such as a display monitor—not shown—of a desktop computing system). Also included in the exemplary computing device 700 is an input subsystem 728. The input subsystem 728 provides the ability to the device user to interact with the computing system 700, including interaction with a dynamic user-interaction control 104. In one embodiment, the input subsystem 728 includes (either as an integrated device or an external device) a touch-sensitive device. Further, in one embodiment the display window of the display subsystem 714 and the input device of the input subsystem 728 are the same device (and are touch-sensitive.)

Still further included in the exemplary computing device 700 is a dynamic user-interaction component 720. The dynamic user-interaction component 720 interacts with the input subsystem 728 and the display subsystem 714 to present a dynamic user-interaction control 104 for interaction by a device user. The dynamic user-interaction component 720 includes a continuous panning component 722 that implements the continuous panning features of a dynamic user-interaction control 104 described above. Similarly, the dynamic user-interaction component 720 includes a zoom component 724 that implements the various aspects of the zooming features of a dynamic user-interaction control 104 described above. The presentation component 726 presents a dynamic user-interaction control 104 upon the dynamic user-interaction component 720 detecting a triggering event, and may also be responsible for dismissing the dynamic user-interaction control upon a dismissal event.

Those skilled in the art will appreciate that the various components of the exemplary computing device 700 of FIG. 7 described above may be implemented as executable software modules within the computing device, as hardware modules (including SoCs—system on a chip), or a combination of the two. Moreover, each of the various components may be implemented as an independent, cooperative process or device, operating in conjunction with one or more computer systems. It should be further appreciated, of course, that the various components described above in regard to the exemplary computing device 700 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

As mentioned above, aspects of the disclosed subject matter may be implemented on a variety of computing devices, including computing devices that do not have a touch-sensitive input device. Indeed aspects of the disclosed subject matter may be implemented on computing devices through stylus, mouse, or joystick input devices. Similarly, aspects of the disclosed subject matter may also work with pen and touch (on suitable surfaces) where the non-dominant hand is using the dynamic user-interaction control with touch while the dominant hand is using the stylus. Accordingly, the disclosed subject matter should not be viewed as limited to touch-sensitive input devices.

It should be appreciated that the panning and zooming activities/interaction described above may be combined with other user interactions. For example, as a user is panning or zooming the displayed content 106, the user may finish the panning with a flick gesture.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for interacting with content displayed in a display window, the method comprising each of the following as implemented by a processor:
detecting a triggering event for interacting with content displayed in a display window;
presenting a dynamic user-interaction control on the display window;
detecting user activity in regard to the dynamic user-interaction control;
determining whether the detected user activity corresponds to a panning activity or a zooming activity; and
implementing the detected user activity with regard to the display of the content in the display window.

2. The computer-implemented method of claim 1, wherein the detected user activity corresponds to a panning activity, and wherein the method further comprises:
determining a panning rate and direction; and
continuously panning the display window in regard to the displayed content in the determined direction and at the determined rate until a terminating event is detected.

3. The computer-implemented method of claim 2, wherein determining a panning rate comprises determining the panning rate according to a function of the distance between an origin location of the user activity and a current location of the user activity.

4. The computer-implemented method of claim 2, wherein determining a panning direction comprises determining a direction between the origin location of the user activity and a current location of the user activity.

5. The computer-implemented method of claim 2, further comprising:
detecting a change in the current location of the user activity;
determining an updated panning direction and an updated panning rate according to a function of the distance between the origin location of the user activity and the new current location of the user activity; and
continuously panning the display window in regard to the displayed content in the updated panning direction and at the updated panning rate until a terminating event is detected.

6. The computer-implemented method of claim 2, further comprising:
detecting a release event; and
dismissing the dynamic user-interaction control from the display window after waiting a predetermined threshold amount of time without any additional device user interaction with the dynamic user-interaction control.

7. The computer-implemented method of claim 1, wherein the detected user activity corresponds to a zoom activity, and wherein the method further comprises:
determining a rotational angle from an origin location of user activity to a current location of user activity;
determining a zoom amount according to the determined rotational angle; and
updating the zoom of the displayed content in the display window as a function of the determined zoom amount.

8. The computer-implemented method of claim 7, further comprising:
detecting a change in the current location of the user activity;
determining an updated zoom value rotational angle from the origin location of user activity to an updated current location of user activity; and
updating the zoom of the displayed content in the display window as a function of the updated zoom amount.

9. The computer-implemented method of claim 1, wherein the dynamic user-interaction area comprises a panning area and a zooming area, and wherein determining whether the detected user activity corresponds to a panning activity or a zooming activity comprises determining whether the detected user activity falls within the panning area or the zooming area.

10. The computer-implemented method of claim 9, wherein determining whether the detected user activity corresponds to determining that the detected user activity corresponds to a panning activity upon determining that the user activity moves from an origin location and away from the origin direction along a vector.

11. The computer-implemented method of claim 9, wherein determining whether the detected user activity corresponds to determining that the detected user activity corresponds to a zooming activity upon determining that the user activity moves from an origin location along an arc within the dynamic user-interaction control.

12. A computer-readable medium bearing computer-executable instructions which, when executed on a computing system comprising at least a processor, carry out a method for interacting with content displayed in a display window, the method comprising:
detecting a triggering event for interacting with content displayed in a display window;
presenting a dynamic user-interaction control on the display window;
detecting user activity in regard to the dynamic user-interaction control;
determining whether the detected user activity corresponds to a panning activity or a zooming activity; and
implementing the detected user activity with regard to the display of the content in the display window.

13. The computer-readable medium of claim 12, wherein the detected user activity corresponds to a panning activity, and wherein the method further comprises:
determining a panning rate and direction; and
continuously panning the display window in regard to the displayed content in the determined direction and at the determined rate until a terminating event is detected.

14. The computer-readable medium of claim 13, wherein determining a panning rate comprises determining the panning rate according to a function of the distance between an origin location of the user activity and a current location of the user activity, and wherein determining a panning direction comprises determining a direction between the origin location of the user activity and a current location of the user activity.

15. The computer-readable medium of claim 12, wherein the method further comprises:
detecting a change in the current location of the user activity;
determining an updated panning direction and an updated panning rate according to a function of the distance between the origin location of the user activity and the new current location of the user activity; and
continuously panning the display window in regard to the displayed content in the updated panning direction and at the updated panning rate until a terminating event is detected.

16. The computer-readable medium of claim 12, wherein the method further comprises:
detecting a release event; and
dismissing the dynamic user-interaction control from the display window after waiting a predetermined threshold amount of time without any additional device user interaction with the dynamic user-interaction control.

17. The computer-readable medium of claim 12, wherein the detected user activity corresponds to a panning activity, and wherein the method further comprises:
determining a rotational angle from an origin location of user activity to a current location of user activity;
determining a zoom amount according to the determined rotational angle; and
updating the zoom of the displayed content in the display window as a function of the determined zoom amount.

18. The computer-readable medium of claim 17, wherein the dynamic user-interaction area comprises a panning area and a zooming area, and wherein determining whether the detected user activity corresponds to a panning activity or a zooming activity comprises determining whether the detected user activity falls within the panning area or the zooming area.

19. The computer-readable medium of claim 18:
wherein determining whether the detected user activity corresponds to determining that the detected user activity corresponds to a panning activity upon determining that the user activity moves from an origin location and away from the origin direction along a vector; and
wherein determining whether the detected user activity corresponds to determining that the detected user activity corresponds to a zooming activity upon determining that the user activity moves from an origin location along an arc within the dynamic user-interaction control

20. A computer system for interacting with content displayed in a display window, the system comprising a processor and a memory, wherein the processor executes instructions stored in the memory as part of or in conjunction with additional components to interact with the content displayed in the display window, the additional components comprising:
a display subsystem through which content may be displayed via a display window;
an input subsystem through which a user may interact with the computer system; and
a dynamic user-interaction component for presenting a dynamic user-interaction control on the display window in response to detecting a triggering event, wherein the dynamic user-interaction component comprises:
a continuous panning component for providing panning of the content with regard to the display window;
a zoom component for providing zooming of the content with regard to the display window; and
a presentation component for displaying the dynamic user-interaction control on the display window in response to the triggering event.
